(19) United States
(12) Patent Application Publication
(10) Pub. No.: US 2018/0248580 A1
(43) Pub. Date: Aug. 30, 2018

(54) CELL PHONE CASE

(71) Applicant: Robert Edman, Laguna Hills, CA (US)

(72) Inventor: Robert Edman, Laguna Hills, CA (US)

(21) Appl. No.: 15/445,685

(22) Filed: Feb. 28, 2017

(51) Int. Cl. H04B 1/3877; A45F 5/00; H04B 1/3888

(52) U.S. Cl. CPC H04B 1/3877; A45F 5/00; A45F 2200/0516; A45C 2200/15; H04B 1/3888

(57) ABSTRACT

A cell phone case for holding a cell phone. A rubber sleeve surrounds the cell phone. A hard case contains the rubber sleeve. The hard case has a finger loop that is pivotally attached to the hard case and a stand that is also pivotally attached to the case. The case has a finger loop pocket and a stand pocket that houses the finger loop and stand when the finger loop and stand are in the closed position. The finger loop and stand are housed in the pockets so that they do not extend above the hard case planer surface when the finger loop and stand are in the closed position.

The present invention relates to cell phones and in particular to cases for cell phones.

### BACKGROUND OF THE INVENTION

Cellular telephones (also known as cell phones) are continuously becoming increasingly more popular and are a very much a part of main stream society. While at first only a few individuals owned cell phones, in recent years it is very common for every member of the family to operate their own cell phone. Even young children routinely carry their own cell phones. Moreover the cell phone has evolved and so that it is now used only part of the time as an actual telephone. Cell phones also commonly function as personal computers and also as cameras.

Indeed, the cell phone camera has given birth to a modern photographic trend commonly known as the “selfie”. It is very common for cell phone users to use the camera feature of their cell phone to take photographic images of themselves and their friends while holding the camera at arm's length and aiming it back at their own faces. The selfie, however, can require an awkward gripping position and sometimes the cell phone may drop or it may be difficult to properly manipulate the cell phone.

Some prior art cell phone cases include added attachments to the cell phone case designed to add useful features to the case. However, these attachments extend outwards from the case and may break off or get stuck in the user's pocket or bag when grabbed by the user.

What is needed is a better cell phone case with improved attachments.

### SUMMARY OF THE INVENTION

The present invention provides a cell phone case for holding a cell phone. A rubber sleeve surrounds the cell phone. A hard case contains the rubber sleeve. The hard case has a finger loop that is pivotally attached to the hard case and a stand that is also pivotally attached to the case. The case has a finger loop pocket and a stand pocket that houses the finger loop and stand when the finger loop and stand are in the closed position. The finger loop and stand are housed in the pockets so that they do not extend above the hard case planer surface when the finger loop and stand are in the closed position, thereby making the cell phone case smoother and less likely to get caught in the user's pocket or bag.

### BRIEF DESCRIPTIONS OF THE DRAWINGS

FIGS. 1-2 show a preferred embodiment of the present invention.

FIGS. 3-6 show a preferred hard case.

FIGS. 7-8 show a preferred rubber sleeve.

FIG. 9 shows a preferred finger loop.

FIGS. 10-11 show a preferred stand.

FIG. 12-14 shows a finger loop pivoted out for usage.

FIG. 15 shows a stand pivoted outward for usage.

FIGS. 16-19 show details of the finger loop pivoting mechanism.

FIG. 20 shows another preferred embodiment of the present invention.

FIG. 21 shows another preferred embodiment of the present invention.

### DETAILED DESCRIPTION OF THE PREFERRED EMBODIMENTS

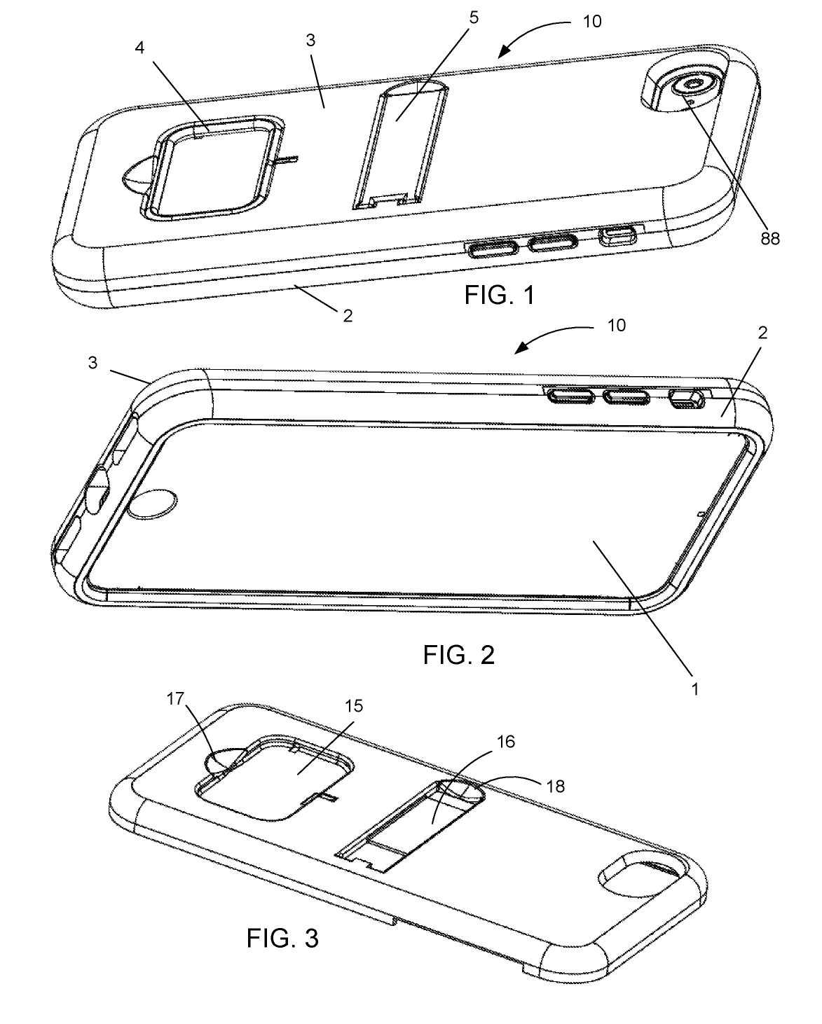

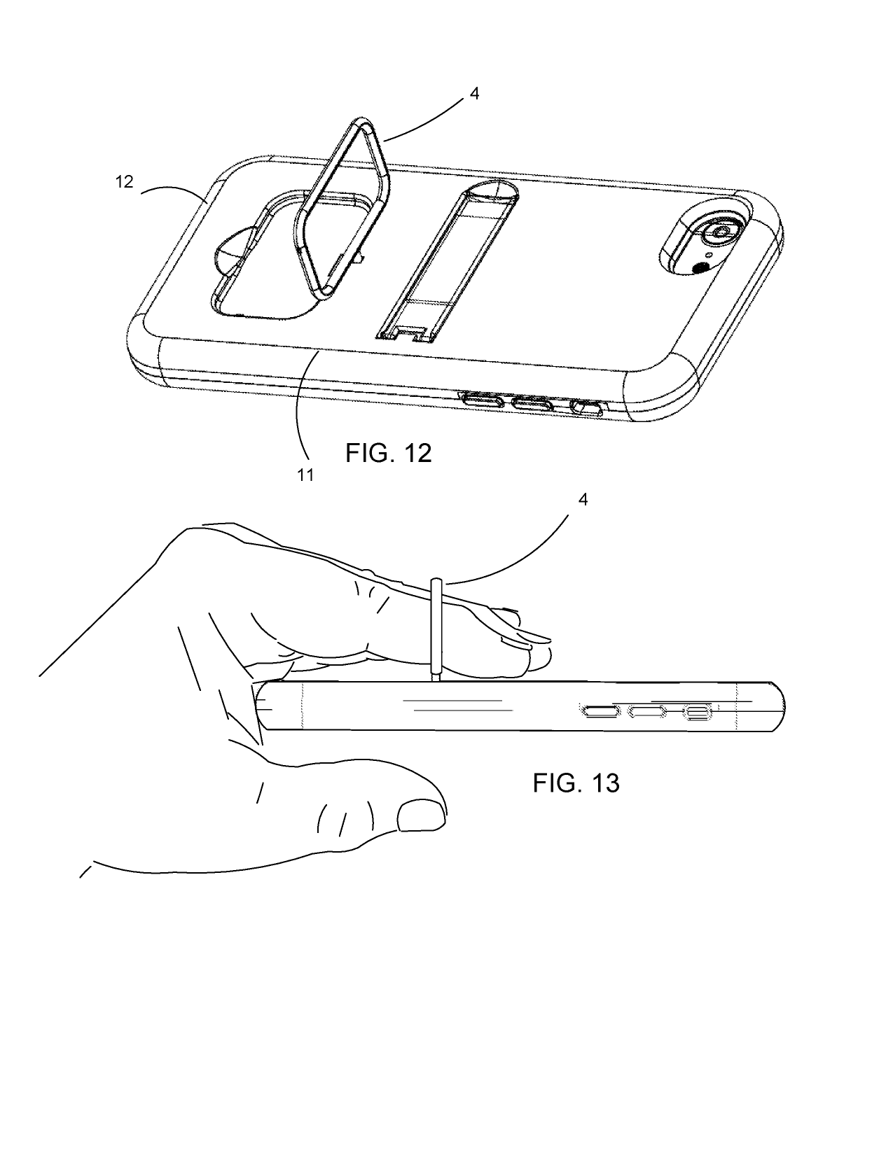

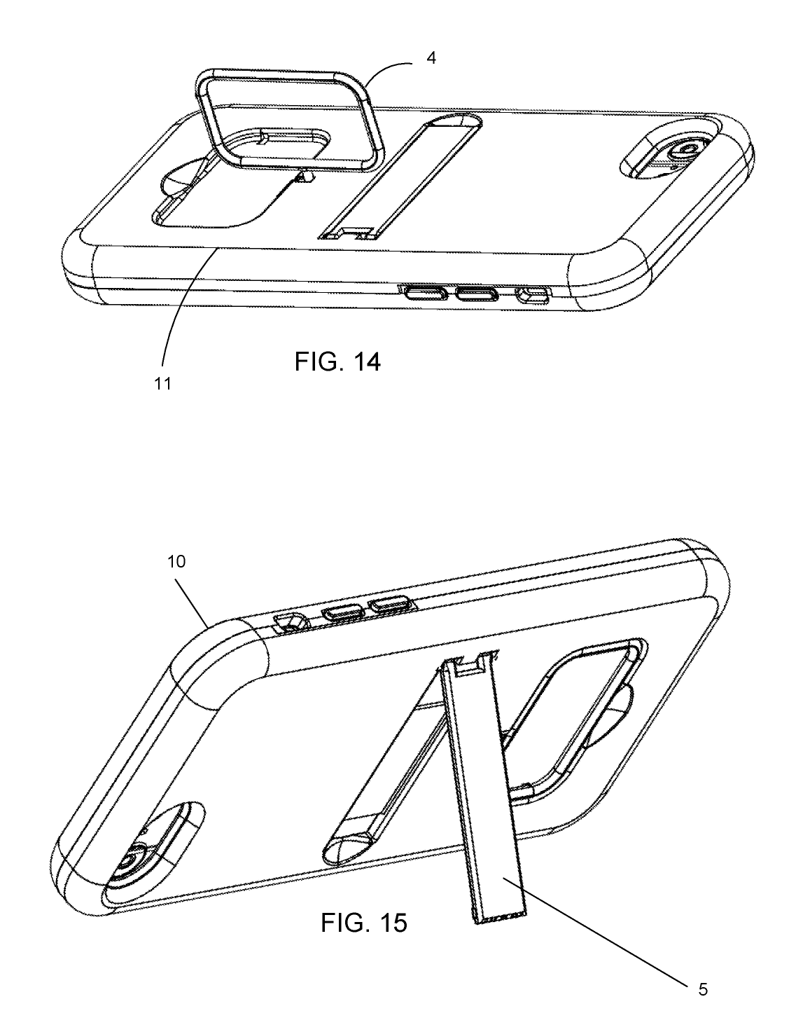

FIGS. 1 and 2 show a preferred embodiment of the present invention. Cell phone 1 is inserted inside rubber sleeve 2 of cell phone case 10. Rubber sleeve 2 is then press fit into hard case 3. Hard case 3 includes finger loop 4 and stand 5. Finger loop 4 and stand 5 are both pivotally attached to hard case 3. For example, FIG. 15 shows stand 5 after it has been pivoted so that it is in its open position and is supporting cell phone case 10. Also, FIGS. 12 and 14 show finger loop 4 after it has been pivoted and in the open position. In FIG. 12, finger loop 4 is arranged so that it is perpendicular to long edge 11 and parallel to short edge 12. In FIG. 14, finger loop 4 has been pivoted so that it is parallel to long edge 11 and perpendicular to short edge 12. The user may choose either orientation depending on how he wishes the orientation for the photo to appear (i.e., landscape or portrait) as he takes a selfie photo. For example, in FIG. 13 the user has chosen the orientation of FIG. 12. This will result in a landscape image. Camera lens 88 of cell phone 1 is shown in FIG. 1.

It should be noted that both finger loop 4 and stand 5 are contained within pockets within hard case 3 so that neither finger loop 4 nor stand 5 extend above the top planer surface of hard case 3 when finger loop 4 and stand 5 are closed and in the down position as shown in FIG. 1. This prevents finger loop 4 or stand 5 from getting caught on items when stowed away inside the user's bag, purse or pocket.

### Hard Case

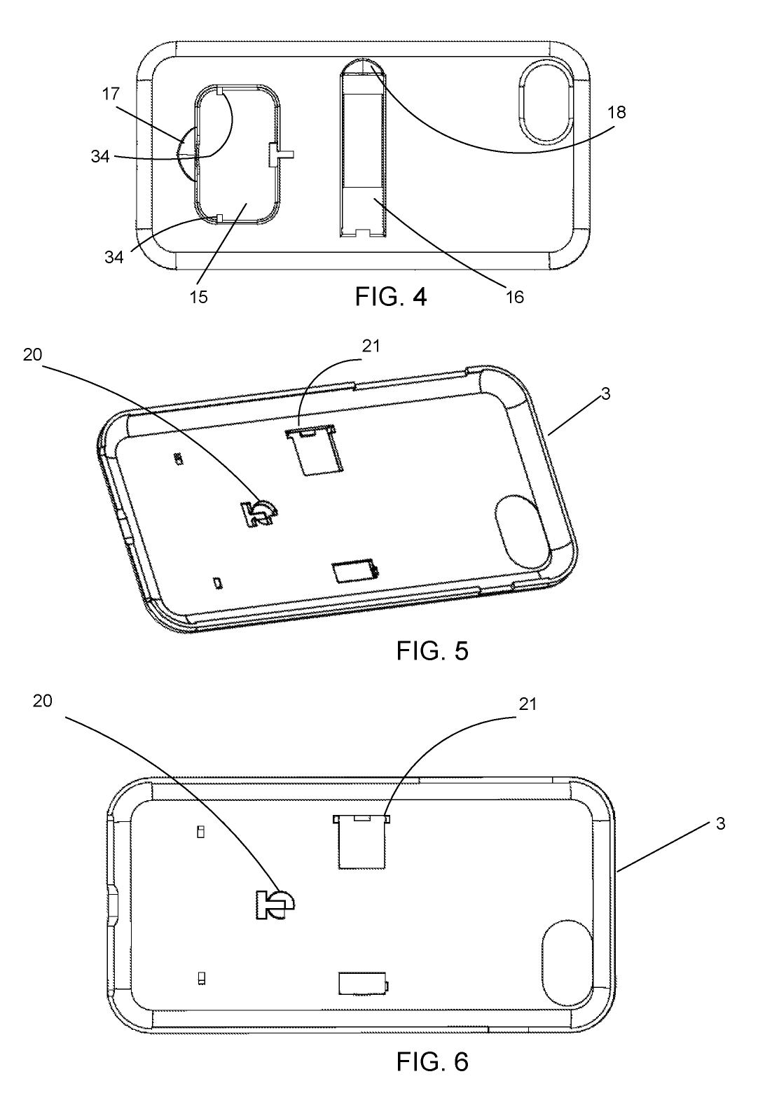

FIG. 3 shows a top perspective view of hard shell case 3 and FIG. 4 shows a top view of hard case 3. Hard case 3 is preferably fabricated from plastic. When connected, finger loop 4 is pivotally connected to hard case 3 and fits snuggly inside pocket 15. Stand 5 is also pivotally connected to hard case 3 and fits snuggly inside pocket 16. Pocket 15 include finger access area 17 for ease of grabbing finger loop 4 when pivoting open the finger loop. Likewise, pocket 16 includes finger access area 18 to increase the ease of grabbing stand 5 when pivoting open the stand.

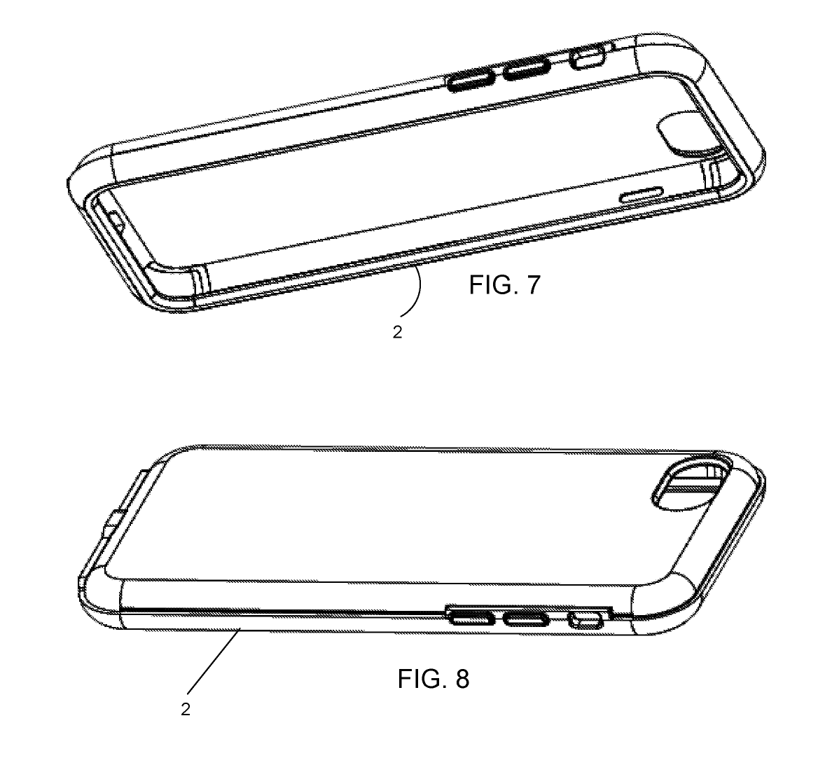

FIGS. 5 and 6 show the bottom of hard case 3. Loop pivot attachment section 20 allows for pivot attachment of finger loop 4 and allows for finger loop for to change orientation in a fashion as described above. Stand pivot attachment section 21 allows for pivot attachment of stand 5 and pivot action as described above.

### Rubber Sleeve

FIGS. 7 and 8 show perspective views of rubber sleeve 2. Cell phone 1 is inserted into rubber sleeve 2, as shown in FIG. 1. Rubber sleeve 2 is preferably fabricated from silicone and functions to protect cell phone 1 if cell phone 1 is inadvertently dropped. Rubber sleeve 2 is press fit into hard case 3 as described above.

### Pivotally Attached Finger Loop

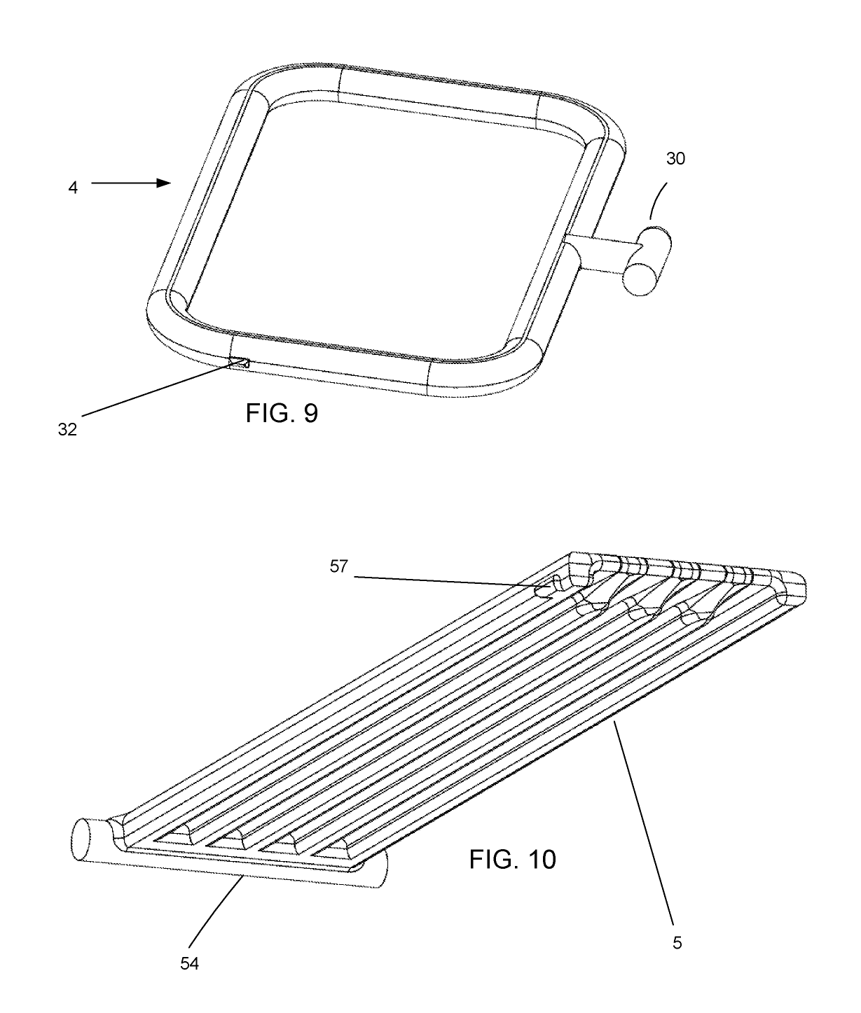

FIG. 9 shows a perspective view of finger loop 4. Finger loop 4 is preferably fabricated from plastic. Finger loop 4 includes pivot axis 30 and retaining tabs 32 (only one tab 32 shown in FIG. 9). Retaining tabs 32 function to engage tab receptors 34 of hard case 3 (FIG. 4). Consequently, tabs 32 function to hold finger loop 4 inside pocket 1615 when in a closed position as shown in FIG. 1. When in the closed position finger loop 4 does not extend higher than the surface of hard case 3.

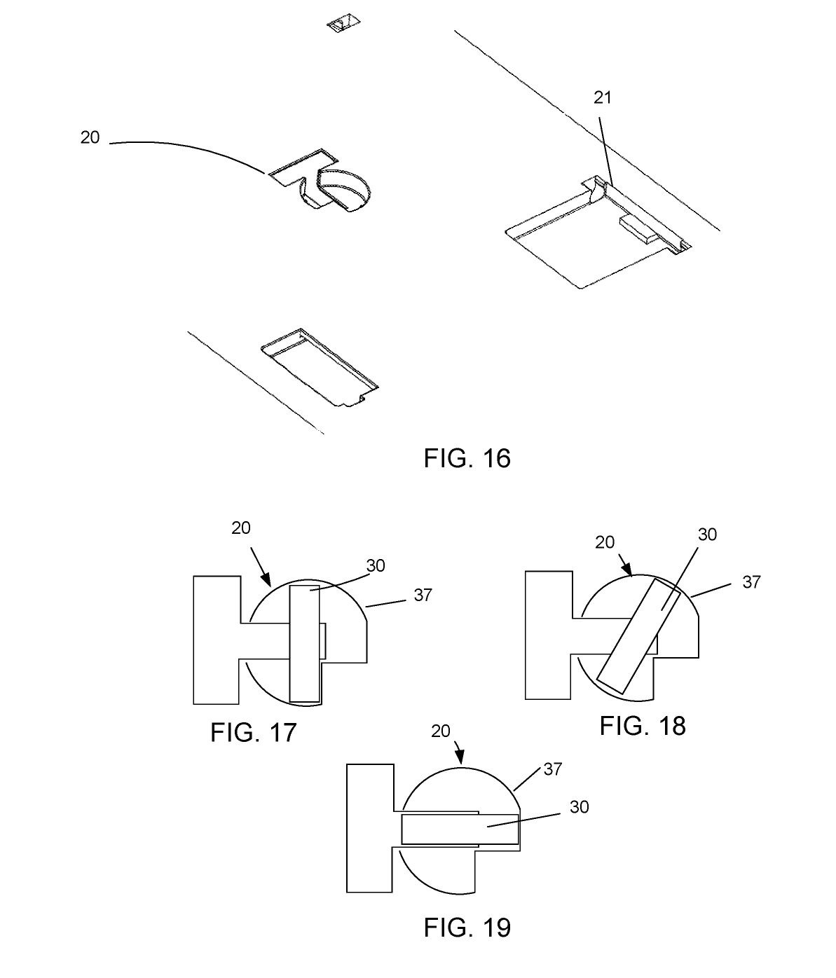

Pivot axis 30 is inserted into loop pivot attachment section 20 (FIGS. 5 and 6). Loop pivot section 20 allows for 90 degree rotation of pivot axis 30. FIG. 16 shows a detailed close up perspective view of loop pivot attachment section 20. FIGS. 17-19 show a top view of loop pivot section 20 with pivot axis 30 inserted. In FIG. 16 pivot axis 30 is perpendicular to long edge 11 to orient finger loop 4 as shown in FIG. 12. In FIG. 18 pivot axis 30 is parallel to long edge 11 to orient finger loop 4 as shown in FIG. 14. FIG. 17 shows pivot axis 30 as it is being position from the position shown in FIG. 12 to the position shown in FIG. 14. To permit the rotational movement from the position shown in FIG. 16 to the position shown in FIG. 18, hard case 3 includes three-quarter circular rotation section 37 to allow for 90 degree rotation as shown.

### Pivotally Attached Stand

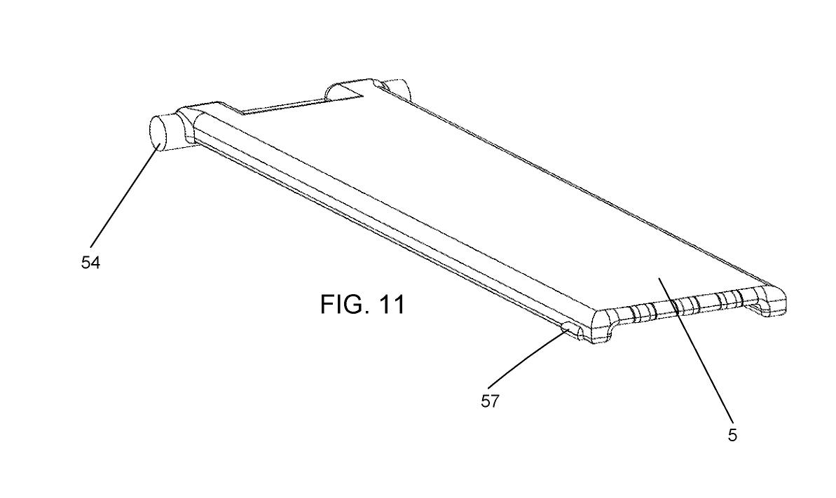

FIGS. 10 and 11 show perspective views of stand 5. Stand 5 is preferably fabricated from hard plastic and includes stand pivot axis 54. Stand pivot axis 54 engages stand pivot attachment section 21 to allow for a pivoting attachment of stand 5 to hard case 3. Stand 5 also includes retaining tab 57. Retaining tab 57 functions to engage tab receptor 59 of hard case 3 (FIG. 4). Consequently, tab 57 functions to hold stand 5 inside pocket 16 when in a closed position as shown in FIG. 1. When in the closed position stand 5 does not extend higher than the surface of hard case 3.

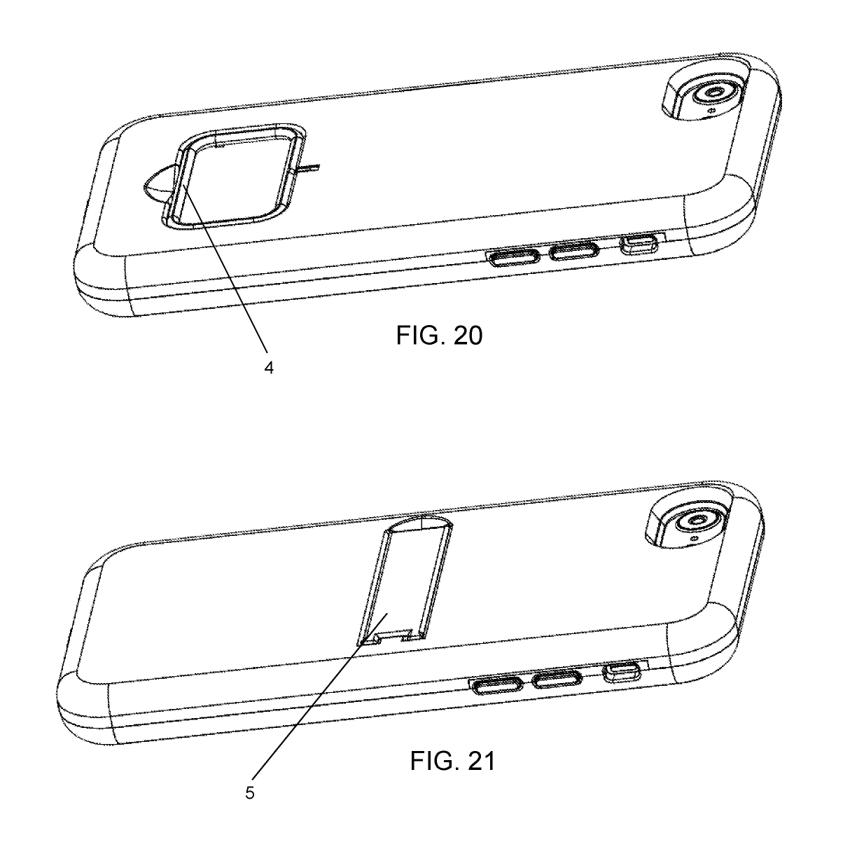

Although the above-preferred embodiments have been described with specificity, persons skilled in this art will recognize that many changes to the specific embodiments disclosed above could be made without departing from the spirit of the invention. For example, the above preferred embodiments show both pivotally attached finger loop 4 and pivotally attached stand 5 attached to cell phone case 10, it would be possible to make a cell phone case 10 that had only finger loop 4 (FIG. 20) or a cell phone case 10 that had only stand 5 (FIG. 21). Therefore, the attached claims and their legal equivalents should determine the scope of the invention.

1) A cell phone case for holding a cell phone, said cell phone case comprising:
A. a rubber sleeve for surrounding the cell phone
B. a hard case for containing the rubber sleeve, said hard case comprising:
1. a hard case planar surface,
2. a finger loop pivotally connected within said hard case,
3. a finger loop pocket for holding said finger loop when it is in a finger loop closed position,
4. a stand pivotally connected within said hard case,
5. a stand pocket for holding said stand when it is in a stand closed position,
wherein said finger loop and said stand do not extend above said hard case planar surface when said finger loop is in said finger loop closed position and said stand is in said stand closed position.

2) The cell phone case as in claim 1, wherein said rubber sleeve is silicone.

3) The cell phone case as in claim 1, wherein said hard case is plastic.

4) The cell phone case as in claim 1, wherein said cell phone case comprises a long edge, wherein said finger loop may be pivoted so that it is either parallel or perpendicular to said long edge.

5) The cell phone case as in claim 1 wherein said finger loop comprises a pivot axis and wherein said hard case comprises a loop pivot attachment section, wherein said finger loop pivot axis engages said loop pivot attachment section.

6) The cell phone case as in claim 5, where said loop pivot attachment section comprises a three-quarter circular rotation section to allow for ninety degree rotation.

7) The cell phone case as in claim 1 wherein said stand comprises a pivot axis and wherein said hard case comprises a stand pivot attachment section, wherein said stand pivot axis engages said stand pivot attachment section.

8) The cell phone case as in claim 1, wherein said finger loop comprises at least one retaining tab for retaining said finger loop in said finger loop pocket when said finger loop is in said closed position.

9) The cell phone case as in claim 1, wherein said stand comprises at least one retaining tab for retaining said stand in said stand pocket when said stand is in said closed position.

10) The cell phone case as in claim 1, wherein said finger loop pocket comprises a finger access area to allow finger access when pivoting said finger loop.

11) The cell phone case as in claim 1, wherein said stand pocket comprises a finger access area to allow finger access when pivoting said stand.

12) A cell phone case for holding a cell phone, said cell phone case comprising:
A. a rubber sleeve for surrounding the cell phone
B. a hard case for containing the rubber sleeve, said hard case comprising:
1. a hard case planar surface,
2. a finger loop pivotally connected within said hard case,
3. a finger loop pocket for holding said finger loop when it is in a finger loop closed position,
4. a stand pivotally connected within said hard case,
5. a stand pocket for holding said stand when it is in a stand closed position,
C. a long edge, wherein said finger loop may be pivoted so that it is either parallel or perpendicular to said long edge,
D. a finger loop pivot axis,
E. a hard case loop pivot attachment section, wherein said finger loop pivot axis engages said loop pivot attachment section,
F. a stand pivot axis,
G. a stand pivot attachment section, wherein said stand pivot axis engages said stand pivot attachment section,
H. a finger loop retaining tab for retaining said finger loop in said finger loop pocket when said finger loop is in said finger loop closed position,
I. a stand retaining tab for retaining said stand in said stand pocket when said stand is in said stand closed position,
J. a finger loop finger access area to allow finger access when pivoting said finger loop, and
K. a stand finger access area to allow finger access when pivoting said stand,
wherein said finger loop and said stand do not extend above said hard case planar surface when said finger loop is in said finger loop closed position and said stand is in said stand closed position.
